(19) United States
(12) Patent Application Publication
(10) Pub. No.: US 2011/0046524 A1
(43) Pub. Date: Feb. 24, 2011

(54) PASSIVE EXERCISE APPARATUS

(76) Inventors: Izumi Mihara, Daito-shi (JP); Wataru Sanematsu, Hirakata-shi (JP); Taketora Nakamura, Maibara-shi (JP); Toshio Nakano, Osaka-shi (JP); Yutaka Yamada, Osaka-shi (JP); Youji Kawamoto, Hikone-shi (JP); Yukihiko Kitano, Nishinomiya-shi (JP)

Correspondence Address: Cheng Law Group, PLLC, 1100 17th Street, N.W., Suite 503, Washington, DC, 20036, US

(21) Appl. No.: 12/922,393

(22) PCT Filed: Apr. 17, 2009
(86) PCT No.: PCT/JP2009/058115

§ 371 Date: Sep. 13, 2010

(30) Foreign Application Priority Data
Apr. 18, 2008 (JP) 2008-109440

(51) Int. Cl. A61H 1/00

(52) U.S. Cl. 601/5

(57) ABSTRACT

A passive exercise apparatus in this invention comprises a base, a seat, a driving unit, and a pair of footrests. The seat is disposed on the base. The driving unit is configured to reciprocate the seat past its neutral position relative to the base. A pair of the footrests is arranged on the base at a front of the seat and is spaced from the seat by a predetermined distance. The feature of the invention resides in that the each of the footrests has a top face for contact with a user's foot. Each of the footrest is configured to move the top face between a raised position and a lowered position. The top face is elastically urged toward the raised position.

### TECHNICAL FIELD

The present invention relates to a passive exercise apparatus being configured to assist a user to strengthen muscle of the user's leg by reciprocating the user.

### BACKGROUND ART

Japanese patent application publication No. 2007-89650A discloses a conventional passive exercise apparatus. The conventional passive exercise apparatus comprises a seat, a driving unit, and a pair of footrests. The driving unit is configured to swing the seat in order to swing the user on the seat. The footrests are provided for placing the user's feet. In this conventional passive exercise apparatus, the driving unit periodically swings the seat forward and back in order to periodically swing the user on the seat forward and back. When the user's body is swung, the user's body is plunged forward. At this time, the user braces user's feet by pressing the footrest so as not to pitch forwards from the seat. In this way, the passive exercise apparatus allows the user to brace user's feet. Therefore, the passive exercise apparatus makes it possible for user on the seat to strengthen the muscle of the legs.

In this passive exercise apparatus, the footrest is configured to move upward and downward according to the swing of the seat such that the passive exercise apparatus allows the user to strengthen the muscle of the leg without applying impact to a user's knee. Consequently, the user with diabetes or senior user is able to train user's muscle of the leg. In particular, the footrest is configured to move downward in conjunction with a motion that the user press the footrest. With this configuration, the passive exercise apparatus is configured to swing the user on the seat in a condition where a user's knee angle is kept at 140 degrees. Therefore, the user on the seat is able to brace user's feet with keeping the knee angle at 140 degree repeatedly. Consequently, the user is able to train the muscle around the user's knee without applying impact to a user's knee.

While the passive exercise apparatus is configured to swing the user on the seat with reducing the impact for the user's knee, the training of bracing the user's feet with keeping the knee angle at 140 degrees is not enough to satisfy a user who requires high exercise intensity. With respect to the problem, it is preferred that the passive exercise apparatus is configured to apply a training of bracing the user's knee with a low knee angle such as 90 degrees to the user.

However, in a case where the passive exercise apparatus swings the user with the user's knee angle at 90 degrees, the user's knee is widely moved frontward when the seat moves frontward, and the user's knee widely moves rearward when the seat moves rearward. That is, in the case where the passive exercise apparatus swings the user with the user's knee angle at 90 degrees, the user's knee is widely moves frontward and rearward. When the knee is widely moved between a front and a rear, the user, especially a user's kneecap, receives a large impact.

Therefore, in using the conventional passive exercise apparatus, it is difficult to train the muscle of the user's leg with large exercise intensity without applying the large impact to the user's knee.

### DISCLOSURE OF THE INVENTION

The invention is achieved to solve the problem. The object of this invention is to provide a passive exercise apparatus being configured to apply high exercise intensity to the muscle of the user's leg with reducing the impact applied to the user's knee.

To solve the above problem, a passive exercise in this invention comprises a base, a seat, a driving unit, and a pair of footrests. The seat is disposed on the base. The driving unit is configured to reciprocate the seat past its neutral position relative to the base. A pair of the footrests is arranged on the base at a front of the seat and is spaced from the seat by a predetermined distance. Features of the invention resides in that each of the footrests has a top face for contact with a user's foot. Each of the footrests is configured to move the top face between a raised position and a lowered position. The footrest has the top face being elastically urged toward the raised position.

It is preferred that the footrest comprises a footplate, a post, and a bias means. The footplate is pivotally fixed to the post. The footplate defines said top face on its upper surface. The bias means is configured to apply bias to the footplate in order to move the footplate from the lowered position toward the raised position.

The passive exercise apparatus with these arrangements is configured to apply a reciprocating motion to the user on the seat. When the passive exercise apparatus swings the user toward a front side of the seat, the passive exercise apparatus allows the user to brace a user's feet. At this time, the user's heel moves toward the lower side because the footrest is configured to move a rear end of the footplate between the raised position and the lowered position. Thus, when the user braces user's foot, the user's foot is dorsiflexed. Therefore, when the user's lower body moves toward the footrest, the footrest supports the user's foot to move the user's knee toward the lower side without moving toward the front side by dorsiflexing the user's foot. Therefore, the passive exercise apparatus is configured to apply the reciprocating motion to the user with keeping the user's knee angle at almost 90 degrees and without applying the impact to a user's knee cap. In addition, when the passive exercise apparatus allows the user to brace the user's feet, the passive exercise apparatus effectively strengthen the user's quadriceps muscle and the gastrocnemius. In addition, the passive exercise apparatus is configured to apply an eccentric training of applying the load with stretching the muscle to the gastrocnemius.

It is preferred that the footplate is formed to have a shape so as to support a portion of the foot other than a user's heel.

In this case, the passive exercise apparatus is configured to effectively strengthen the user's plantar arches when the passive exercise apparatus allows the user to brace the user's feet.

On the other hand, it is preferred that the footrest comprises a toe support and an elastically deformable member. The elastically deformable member has an upper surface which defines the top face. The elastically deformable member is deformable under pressure to move the top face between the raised position and the lowered position.

In this case, the passive exercise apparatus is configured to allow the user to strengthen the user's quadriceps muscle and the gastrocnemius without applying the impact to the user's knee cap. In addition, the passive exercise apparatus is configured to apply the eccentric training to the user's gastrocnemius.

It is preferred that the elastically deformable member is formed to have a shape so as to support a portion other than a user's toe.

It is preferred that the elastically deformable member is formed to have a shape so as to support a portion other than a user's heel.

In this case, the passive exercise apparatus is configured to effectively strengthen the user's plantar arches when the passive exercise apparatus allows the user to brace the user's feet.

Furthermore, it is preferred that the driving unit is configured to swing the seat back and forth past the neutral position in a forward/rearward direction of the base. On the other hand, it is also preferred that the driving unit is configured to move the seat up and down past the neutral position in a vertical direction.

In this case, the passive exercise apparatus is configured to allow the user to brace user's feet effectively.

Furthermore, it is preferred that the passive exercise apparatus further comprises a positioning mechanism. The positioning mechanism is configured to slide the footrest in a forward or rearward direction in order to vary the predetermined distance. On the other hand, it is also preferred that the passive exercise apparatus further comprise a positioning mechanism which is configured to move the footrest an upward or downward direction in order to vary a distance between the top face and a seating face of the seat.

In this case, it is possible to adjust the distance between the seat and the footrest.

### BRIEF DESCRIPTION OF THE DRAWINGS

FIG. 1 shows a schematic side view of the passive exercise apparatus with user on the seat of a first embodiment in this invention.

FIG. 2 shows a side view of the passive exercise apparatus of the first embodiment in this invention.

FIG. 3 shows an exploded perspective view of a driving unit and a housing of the first embodiment in this invention.

FIG. 4 shows an exploded perspective view of the driving unit of the first embodiment in this invention.

FIG. 5 shows a perspective view of the driving unit of the first embodiment in this invention.

FIG. 6 shows a side view of the driving unit of the first embodiment in this invention.

FIG. 7 shows an exploded perspective view of the driving unit of the first embodiment in this invention.

FIG. 8(a) shows a trajectory of a center of the seat seen from above of the passive exercise apparatus.

FIG. 8(b) shows a trajectory of a center of the seat seen from right of the passive exercise apparatus.

FIG. 9 shows a schematic side view of the passive exercise apparatus with the user on the seat of a second embodiment in this invention.

FIG. 10(a) shows an expanded cross sectional view of a base of the second embodiment.

FIG. 10(b) shows an expanded perspective view of a base of a modification of the second embodiment.

FIG. 11 shows a schematic side view of the passive exercise apparatus of the third embodiment in this invention.

FIG. 12(a) shows a schematic side view of the positioning mechanism in a condition where a supporting plate is lifted.

FIG. 12(b) shows a schematic side view of the positioning mechanism in a condition where the supporting plate is lowered.

FIG. 13(a) shows a schematic side view of a positioning mechanism of a modification of this invention in a condition where the supporting plate is lifted.

FIG. 13(b) shows a schematic side view of a positioning mechanism of the modification of this invention in a condition where the supporting plate is lowered.

FIG. 14 shows a schematic side view of a passive exercise apparatus with the positioning mechanism.

FIG. 15 shows a schematic side view of a passive exercise apparatus of a fourth embodiment in this invention.

### BEST MODE FOR CARRYING OUT THE INVENTION

### First Embodiment

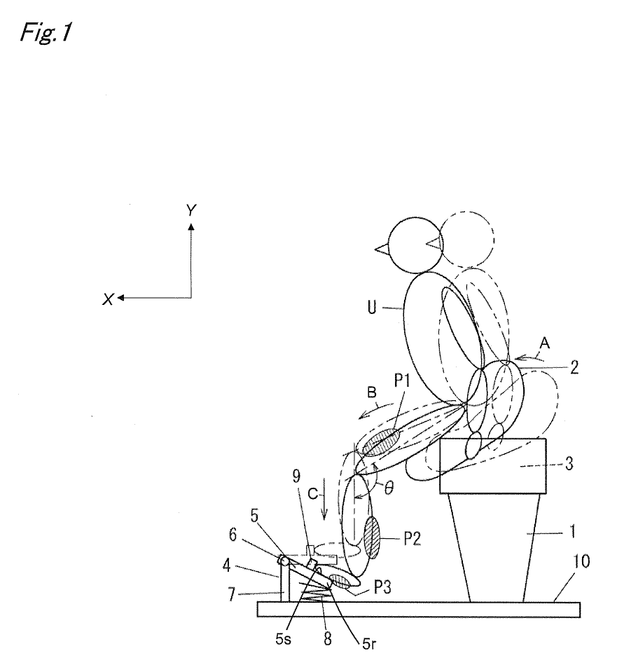

Now a passive exercise apparatus in this invention is explained with attached drawings. FIG. 1 is a schematic view of a first embodiment of the passive exercise apparatus in this invention. In FIG. 1, X direction shows a front side of the passive exercise apparatus, and Y direction shows an upper side of the passive exercise apparatus. Left and right of the passive exercise apparatus is defined by a direction perpendicular to both of the X direction and the Y direction.

As shown in FIG. 1, the passive exercise apparatus in this invention comprises a seat 2, a driving unit 3, a base 10, a pair of footrests 4, and a housing 1.

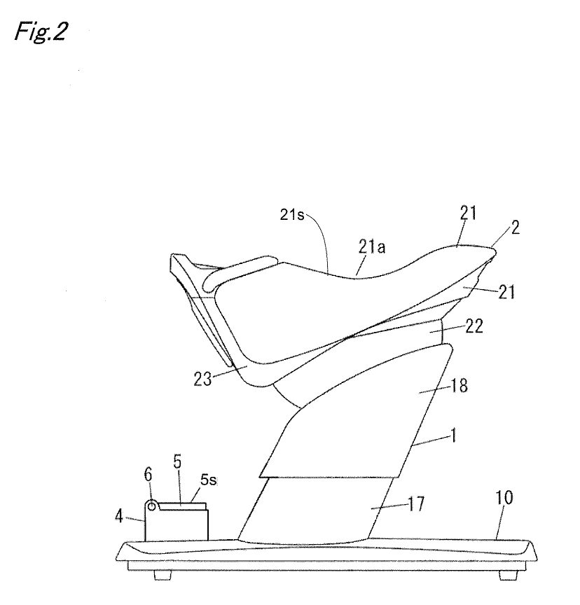

The seat 2 is provided for user U who sits on a seating face 21s in FIG. 2 of the seat 2. The seat 2 is disposed on the housing 1 to be movable on the housing 1. The housing 1 is formed to incorporate the driving unit 3. This housing 1 is disposed on the base 10. Therefore, the seat 2 is configured to be movable frontward, rearward, leftward, rightward, upward, and downward relative to the base 10. A pair of the footrests is arranged at a front of the seat 2 and is spaced from the seat 2 by a predetermined distance.

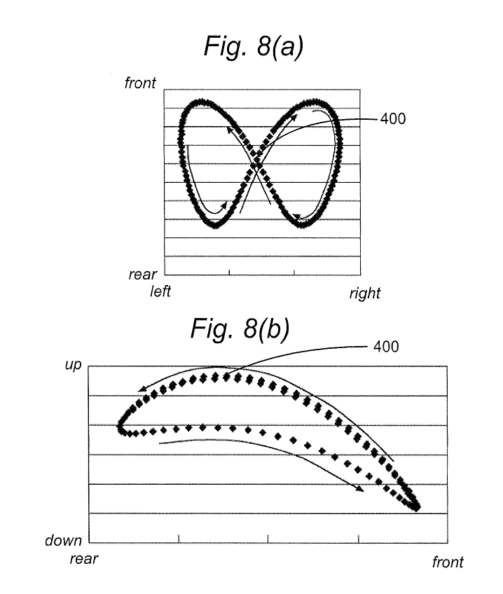

FIG. 8 (a) shows an overhead view of a trajectory of the seat 2 that the driving unit 3 swings. As shown in FIG. 8 (a), the trajectory has figure-of-eight shape. The housing 1 is configured to support the seat 2 on the housing 1 such that the seat 2 is located at a neutral position 400. The driving unit 3 is configured to swing the seat 2 past the neutral position 400 toward a front side, a rear side, a left side, and a right side such that the seat 2 trace out the figure-of-eight. In addition, the driving unit 3 is configured to move the seat 2 toward the front as well as swing the seat 2 downward past the neutral position 400, and is configured to move the seat 2 toward the rear as well as swing the seat 2 upward. In this way, the driving unit 3 is configured to swing the seat 2 toward the front, the rear, the left, the right, and is configured to move the seat 2 upward and downward. That is, the driving unit 3 is configured to reciprocate the seat 2 frontward/rearward, leftward/rightward, and upward/downward past the neutral position 400 along the trajectory in FIG. 8 (a) and FIG. 8 (b). Consequently, the driving unit 3 applies a motion to the seat 2 in order to allow the user U on the seat 2 to brace the user's foot. When the driving unit 3 swings the seat 2 to the front of the left side, the passive exercise apparatus allows the user U on the seat 2 to plunge forward of the leftward. According to the swing, the user brace the user's left foot so as not to be pitched forward from the seat. In this way, the passive exercise apparatus is configured to allow the user to brace user's left foot. On the other hand, when the driving unit 3 swings the seat 2 to the front of the right side, the passive exercise apparatus allows the user U on the seat 2 to plunge forward of the rightward. According to the swing, the user brace the user's right foot so as not to be pitched forward from the seat. In this way, the passive exercise apparatus is configured to allow the user to brace user's right foot. In this way, the passive exercise apparatus is configured to alternately stimulate the muscle of the user's leg.

Both of the footrests 4 has a footplate 5, a post 7, and a spring 8. The footplate 5 is formed to have a plate shape and is formed with an upper surface which comes into contact with a bottom of the user's foot. The post 7 has a shaft 6 having a left-right axis. The footplate 5 is pivotally fixed to the post 7 through the shaft 6 to have the footplate 5 which is movable between a raised position and a lowered position. The spring 8 is configured to apply a spring bias to the rear end 5r of the footplate 5 in order to elastically urge the upper surface 5s of the footplate 5 toward the raised position. In particular, the spring 8 is configured to apply a spring bias to the rear end 5r of the footplate 5 in order to move the rear end 5r of the footplate 5 from the lowered position toward the raised position. That is, the spring 8 acts as a bias means. Besides the spring 8, an air bag, a gel bag, and a dashpot are able to use as the bias means.

The footplate 5 is provided at its upper surface 5s with the locating stopper 9. The locating stopper 9 is disposed at a mid portion of the front-rear direction of the footplate 5. The locating stopper 9 is provided for contacting the user's toe such that the upper surface 5s supports the portion of the user's foot other than the user's heel. In particular, the footplate 5 is provided with the locating stopper 9 to have the upper surface 5s which supports ⅓ to ½ area of the bottom of the user's foot from the user's toe.

As shown in FIG. 1, the footplate 5 is pivotally fixed to the post 7 through the shaft 6 to have the rear end 5r being movable between the raised position drawn by the broken line and the lowered position drawn by the solid line. As shown in FIG. 1, the footplate 5 in the raised position has the rear end located at an upper limit. The footplate 5 in the lowered position has the rear end 5r located at a lower limit. When the user places the user's foot on the footplate 5, the spring 8 receives the pressure through the upper surface 5s of the footplate 5. Therefore, the footplate 5 moves toward the lowered position. Then, the spring 8 generates the spring bias which is applied to the rear end 5r of the footplate 5. This spring bias becomes larger as the rear end 5r of the footplate 5 moves toward the lower limit. Besides the spring 8, a suitable drive mechanism which is configured to urge the footplate 5 toward the raised position as receiving the pressure toward the lower position is capable of employing as the bias means.

According to the passive exercise apparatus with the above configuration, the driving unit 3 is configured to swing the seat 2 toward the front of the left side as well as the lower direction. Therefore, the passive exercise apparatus applies the reciprocating motion to the user U on the seat 2 in order to allow the user U to brace user's left foot when the seat 2 moves toward the front of the left side as well as the lowered side. When the user U braces the user's left foot, the user's heel moves toward the lower side in accordance with the rear end 5r of the footplate 5 because the footplate 5 has the front end which is pivotally fixed to the post 7. Consequently, the user's foot is dorsiflexed by the footplate 5.

Because of the dorsiflex motion of the user's foot, the passive exercise apparatus moves the user's left knee toward the lower direction without moving the user's left knee to the front-back direction, while moving a user's lower body frontward/downward in accordance with the reciprocating motion designated by A in FIG. 1. That is, the passive exercise apparatus with the above arrangement is configured to generate load which is directed toward the front of the left direction designated by B in FIG. 1. Therefore, a part from a user's thigh to the user's knee receives the load. On the other hand, As shown in reference numeral C in FIG. 1, a part from the user's knee to the user's foot little receives the load because the load applied to the part from the knee to the foot is released through the footrest. Then, the passive exercise apparatus allows the user U to repeatedly brace the user's feet alternately from side to side.

Therefore, in a case where the user U sits on the seat 2 with the user's knee angle θ at 90 degrees, the passive exercise apparatus in this invention is configured to reciprocate the user U so as not to move the user's knee frontward/rearward. Consequently, the passive exercise apparatus in this invention is configured to reciprocate the user U to strengthen the muscle of the user's leg without applying a large load to the knee pat. In addition, when the passive exercise apparatus reciprocates the user U, the passive exercise apparatus applies the load to the thigh muscle of the user U. Especially, when the passive exercise apparatus reciprocates the user U, the passive exercise apparatus applies the load to a front side of the thigh muscle P1 of the user U in FIG. 1. Therefore, the passive exercise apparatus is configured to effectively apply the load to the user's quadriceps, thereby strengthening the user's quadriceps. Furthermore, the passive exercise apparatus is configured to apply the load to a region below the user's knee. Especially, the passive exercise apparatus is configured to apply the load to a rear side of the region below the user's knee P2. Therefore, the passive exercise apparatus is configured to effectively apply the load to a user's gastrocnemius. In addition, the passive exercise apparatus is configured to apply the load to the muscle such as the gastrocnemius, while stretching the muscle. Therefore, the passive exercise apparatus is configured to apply an eccentric training having a high muscle-building effect to the user U.

As above mentioned, the passive exercise apparatus in this embodiment is configured to allow the user U to brace user's foot without applying the large load to the knee under the condition of the knee angle at 90 degrees and of the constant lengthwise knee position. Especially, the passive exercise apparatus in this embodiment is configured to apply the eccentric training having the high muscle-training effect to the gastrocnemius. In this case, the user's knee angle is spread to have angles from 100 degrees to 110 degrees by the passive exercise apparatus when the user's foot is dorsiflexed by bracing the user's foot. It is preferred that the knee angle is designed to vary between the 90 degrees and the 140 degrees when the user U braces the user's foot repeatedly.

In addition, the passive exercise apparatus in this invention has the footplate 5 to have the locating stopper 9 such that the footplate 5 has the upper surface 5s which comes into contact with a portion of the foot other than the user's heel. Therefore, the passive exercise apparatus in this invention is configured to strengthen a user's plantar arch P3 in FIG. 1 when the user U braces the user's foot. That is, the passive exercise apparatus is configured to effectively strengthen the parts P1, P2, P3 of the user's leg at the same time.

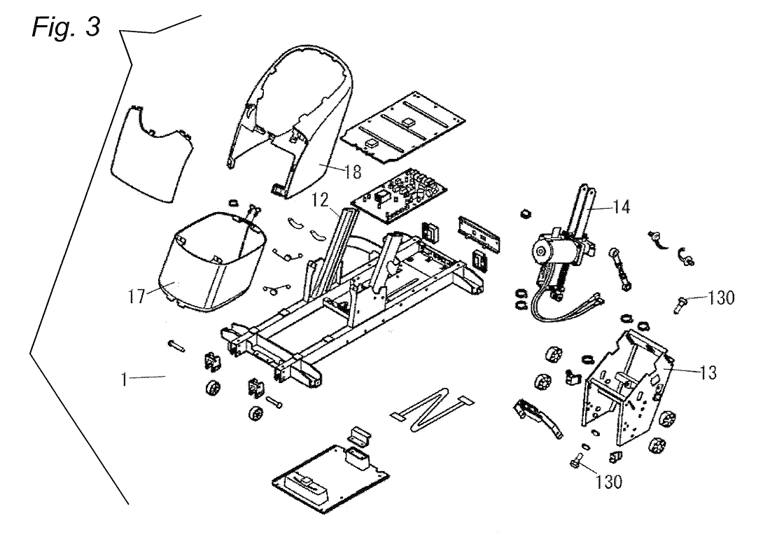

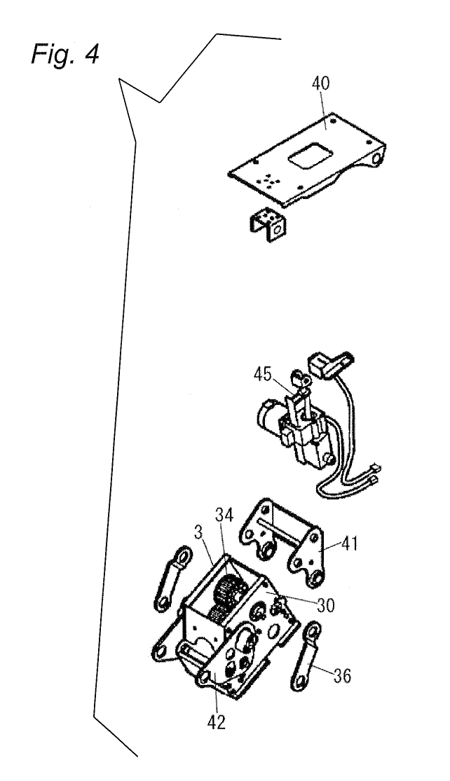

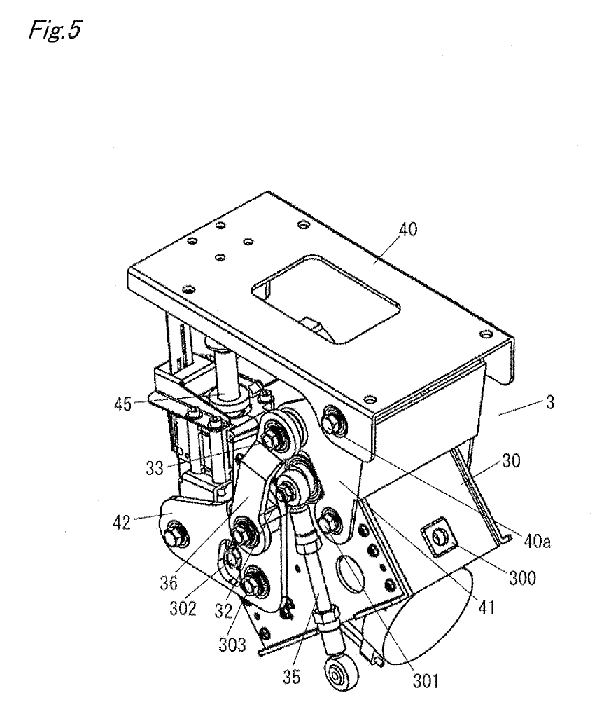

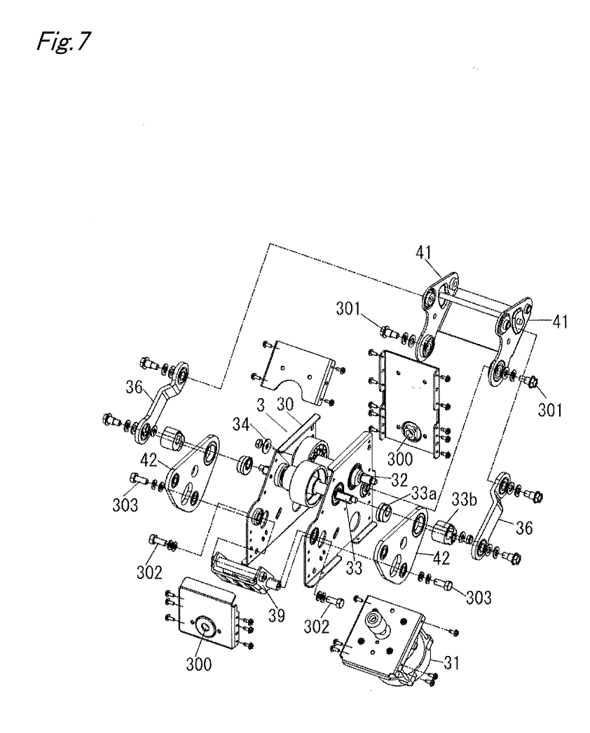

Next, a specific structure of the driving unit 3 is explained with FIG. 2 to FIG. 8. FIG. 3 shows the housing 1 which houses the driving unit 3. The housing 1 comprises a pair of supporting poles 12, a support frame 13, an electrical slide unit 14, a sub cover 17 and a main cover 18. The supporting poles 12 extend diagonally backward from the base 10. The support frame 13 is attached to the supporting poles 12 to be slidable along the supporting poles 12. The electrical slide unit 14 is configured to slide the support frame 13 along the supporting poles 12. The sub cover 17 and the main cover 18 are attached to the base 10 to respectively cover the supporting poles 12 and the support frame 13.

As shown in FIG. 2, the seat 2 comprises a top cover 21, a bottom cover 22, and protectors 23. The bottom cover 22 has a lower end which is coupled with the top cover 21. The protector 23 is attached to the both side of the top cover 21.

The driving unit 3 comprises a movable frame 30, a motor 31, gears 34, a movable plate 40, a pair of link plate 41, and a pair of link plate 42. The movable frame 30 is formed to incorporate the motor 31 and the gear 34. Rotation that the motor generates is transmitted to output shafts 32, 33 through the gear 34. The movable plate 40 is located above the movable frame 30. The movable plate 40 has a rear end which is coupled with the movable frame 30 via the link plates 41, 42. The link plate 41 has an upper end pivotally connected to the rear end of the movable plate 40 through the connection shaft 40a. The movable frame 30 has a front face and a rear face which respectively have bearings. The movable frame 30 is provided at its front face and its rear face with bearings 300 which receive the shaft 130, thereby the movable frame 30 being attached to the housing 1 to be rotatable around an axis of the shaft 130.

The link plate 41 which is coupled to the rear side of the movable plate 40 is connected with a rear side of the movable frame 30 through the shaft 301. On the other hand, link plate 42 is supported by the other end of the rotation plate 39 through the shaft 303. Therefore, the rotation plate 39 has one side which supports the movable frame 30 through the shaft 302 and has the other side which supports the link plate through the shaft 303. The link plate 42 is connected to the front side of the movable plate 40 through an actuator 45 which is extendable. The actuator 45 has an upper end pivotally fixed to the front end of the movable plate 40 through a connection shaft 40b.

The output shaft 32 is eccentrically-connected to the outer surface of the movable frame 30 through the eccentric joint 32a. The output shaft 32 is connected to the supporting frame 13 through the link 35, thereby defining a roll drive section of the driving unit 3.

The output shaft 33 is connected to the link plate 42 through a coupling link 36 and eccentric joints 33a and 33b. The eccentric joint 33a is connected to the link plate 42 to cause a large eccentric rotation to the link plate 42. The eccentric joint 33b is connected to the link plate 41 to cause a small eccentric rotation to the link plate 41. Therefore, the output shaft 33 defines a pitch drive section of the driving unit 3.

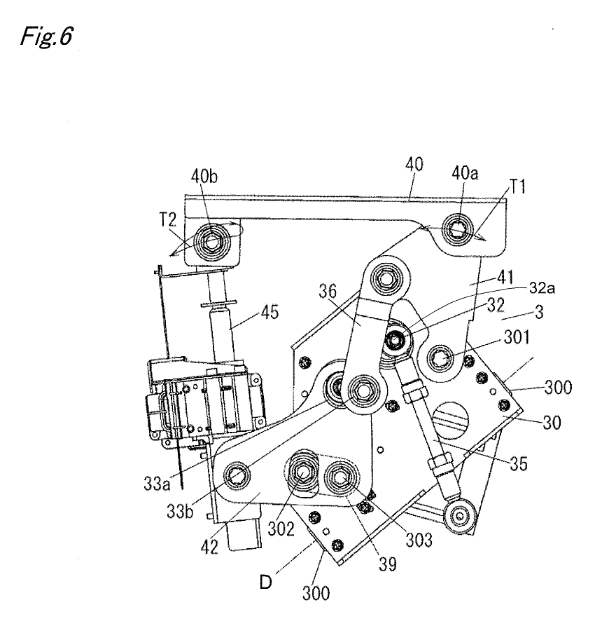

The output shaft 32 is connected to the supporting frame 13 through the eccentric joint 32a and the link 35. Consequently, an eccentric rotation caused by the output shaft 32 is transmitted to the movable frame 30, thereby causing the reciprocating motion around the axis D in FIG. 6.

The output shaft 33 is configured to generate an eccentric rotation by the eccentric joint 33a. The eccentric rotation generated at the eccentric joint 33a is transferred to the front side of the movable plate 40 through the link plate 42 and the actuator 45. Therefore, the motor rotates the output shaft 33 so as to swing the front side of the movable plate 40 frontward/rearward and upward/downward. In addition, the output shaft 33 is configured to generate an eccentric rotation by the eccentric joint 33b. The eccentric rotation generated at the eccentric joint 33b is transferred to the rear side of the movable plate 40 through the coupling link 36 and the link plate 41. Consequently, the motor 31 rotates the output shaft 33 so as to swing the rear side of the movable plate 40 frontward/rearward. Reference numeral T2 in FIG. 6 shows a motion of the connection shaft 40b. Reference numeral T1 in FIG. 6 shows a motion of the connection shaft 40a. As shown in FIG. 6, the front end of the movable plate 40 is moved frontward/rearward at a movement distance. The rear end of the movable plate 40 is moved frontward/rearward at a movement distance same as the predetermined distance that the front end of the movable plate 40 moves frontward/rearward. On the other hand, the rear end of the movable plate 40 is moved upward/downward at a movement distance different from a movement distance that the front end of the movable plate 40 moves upward/downward.

Meanwhile, the connection shaft 40b moves frontward/rearward along the trajectory T2. The connection shaft 40a moves frontward/rearward along the trajectory T1. Compared with the trajectory T1 and T2, the vertical movement distance of the connection shaft 40b is larger than the vertical movement distance of the connection shaft 40a. This is because the shaft 303 is located at a rear side of the connection shaft 40b. In addition, the connection shaft 40b moves frontward along an under side of the trajectory T2 and moves rearward along an upper side of the trajectory T2. This is because the shaft 303 which acts as a fulcrum of the link plate 42 is vertically moved by the rotation plate 39 such that the front side of the movable plate 40 is moved vertically.

The seat 2 is mounted on the housing to have the top cover 21 which is disposed on the movable plate 40. Thus, motor 31 is configured to swing the movable plate 40 with the seat 2 frontward/rearward and leftward/rightward. The motor 31 is configured to rotate the output shaft 32, 33 to swing the movable plate 40 once from the left side to the right side and to swing the movable plate 40 twice from the front side to the rear side at the same time. Therefore, the driving unit 3 is configured to swing the seat 2 to move a center 21a which moves along the trajectory of the figure of eight from the overhead view of the passive exercise apparatus. FIG. 8 (a) shows the trajectory of the center 21a of the seat 2 of the overhead view of the passive exercise apparatus. In addition, the driving unit 3 is configured to move the seat 2 to move a center 21a frontward while moving a center 21a downward, and is configured to move the seat 2 to move a center 21a rearward while moving a center 21a upward. FIG. 8 (b) shows the trajectory of the center 21a of the seat 2 of a right side view of the passive exercise apparatus. The motion of the center 21a of the seat 2 shown in FIG. 8 (b) is caused by the difference between the trajectory T2 of the connection shaft 40b and the trajectory T1 of the connection shaft 40a.

Meanwhile, in this embodiment, the driving unit 3 is configured to swing the seat 2 along the trajectory of the figure of eight. However, the trajectory is not limited to the figure of eight shape. It is preferred that the driving unit 3 is configured to swing the seat 2 along a trajectory of a V-shape or a W-shape instead of the figure of eight.

FIG. 8 shows the motion of the seat 2 by plotting the trajectory of the center 21a of the seat 2 at the same interval of the time. In FIG. 8, a section having a long distance between the points means that the seat 2 moves fast, and a section having a short distance between the points means that the seat 2 moves slow. That is, the increase of the distance between the points means that the seat 2 moves with accelerating. As will be noted from FIG. 8, acceleration of the seat 2 in moving toward the front is larger than acceleration of the seat 2 in moving toward the rear. That is, the driving unit 3 is configured to swing the seat 2 toward the front with the acceleration which is larger than the acceleration that the driving unit 3 swings the seat 2 toward the rear. This is because the passive exercise apparatus applies feeling of being swung forward to the user U on the seat 2. With this configuration, the passive exercise apparatus is configured to apply feeling of being swung forward to the user U.

### Second Embodiment

Next, a passive exercise apparatus of a second embodiment is explained with attached drawings. In this embodiment, the passive exercise apparatus in this embodiment is substantially the same as the passive exercise apparatus explained in the first embodiment. Therefore, features different from the first embodiment is explained in this embodiment. In the drawings, like parts are designated by the same reference numerals.

The passive exercise apparatus in this embodiment comprises the seat 2, the driving unit 3, a base 100, a pair of the footrests 4, the housing 1, and a positioning mechanism 50. The base 100 is provided for mounting a pair of the footrests 4 and the seat 2 which is disposed on the housing 1. The positioning mechanism 50 is configured to slide the footrest 4 in the frontward or rearward direction of the seat 2 and the driving unit 3.

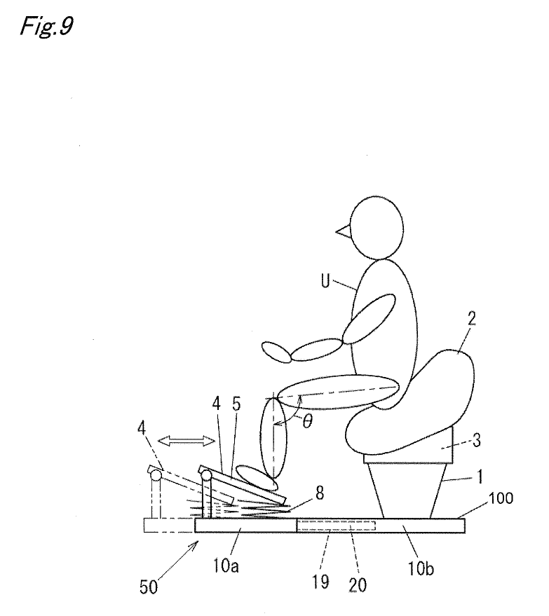

Referring to FIG. 9, the base 100 comprises a front plate 10a and a rear plate 10b. The housing 1 is disposed on the rear plate 10b. The footrests are disposed on the front plate 10a. The front plate 10a is provided at its rear face with a pair of bars 19 which extend toward the rear side. The rear plate 10b is provided with a pair of rails 20 and a pair of openings 26a. The rail 20 is formed along the front-back direction of the rear plate 10b. The opening 26a is formed at a front face of the rear plate 10b to pass the bar 19 into the rail 20. Therefore, the rail 20 receives the bar 19 through the opening 26a. The bar 19 is formed to be slidable along the rail 20. A pair of the bar 19 and a pair of the rail 20 defines the positioning mechanism 50.

In this passive exercise apparatus of this embodiment, the positioning mechanism 50 makes it possible for a pair of the footrests 4 to move toward the front side or the rear side. That is, the positioning mechanism 50 makes it possible to vary a horizontal distance between the seat 2 and the footrest 4. It is possible to obtain the passive exercise apparatus which is configured to adjust a distance between the seat 2 and the footrest 4 to keep a suitable knee angle for a lot of different users having different body types. Therefore, the passive exercise apparatus is configured to apply the reciprocating motion to the user U with the knee angle at 90 degrees when the user U moves the footrest toward the rear side. Meanwhile, the passive exercise apparatus in this embodiment has a pair of the footplates which come into contact with the bottom of the user's feet.

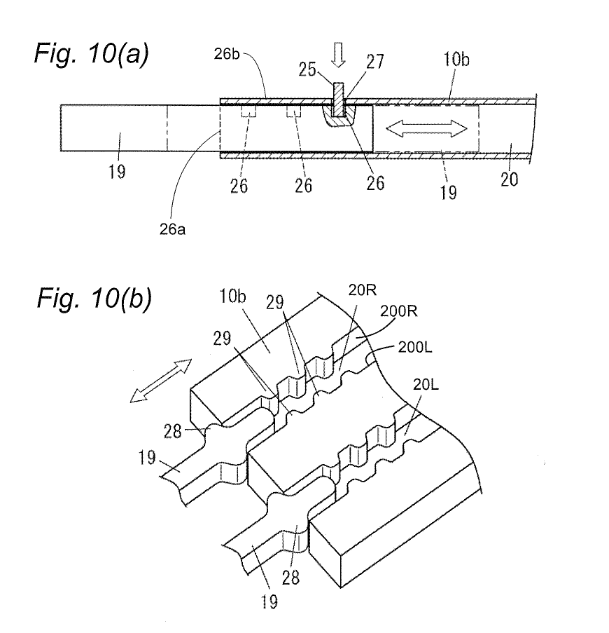

FIG. 10(a) shows a side cross section view of the bar 19 and the rail 20. That is, FIG. 10(a) shows a connection between the bar 19 and the rail 20. As shown in FIG. 10(a), the rail 20 is formed to have upper plate with a plurality of locating holes 26. The locating hole 26 is formed along the bar 19 to be spaced from the other locating hole 26. According to the locating holes 26, an upper wall 26b of the rail 20 is formed to have a hole 27. The bar 19 is fixed to the rail through a pin 25. The pin 25 passes through the hole 27 to be inserted into the locating hole 26. In this way, the footrest 4 is moved toward the front side or the rear side to vary the horizontal distance from the seat 2. In addition, it is preferred that the bar 19 is configured to be coupled to the rail 20 by a latch which is not shown.

On the other hand, FIG. 10 (b) shows a modification of the connection between the bar 19 and the rail 20. The bar 19 is formed at its left face and right face with projections 28. According to the projections 28, the right rail 20R is formed at its left inside face 200L and right inside face 200R with projections 29. The projection 29 of the left inside face 200L is arranged at the left inside face 200L at even interval. The projection 29 of the left inside face 200L is spaced from the other projection 29 of the left inside face 200L by a predetermined distance. The right inside face 200R has the projections 29 same as the projections 29 of the left inside face 200L. Similarly, the left rail 20L has a left inside face and a right inside face same as the right rail 20R. When the user U applies force to move the bar 19 along the rail 20 from the front side, the projection 28 comes into contact with projections 29. At this moment, when the user U further applies the force to move the bar 19 along the rail 20 from the front side, the projections 28 moves toward the rear side with expanding the left inside face and the right inside face of the rail.

### Third Embodiment

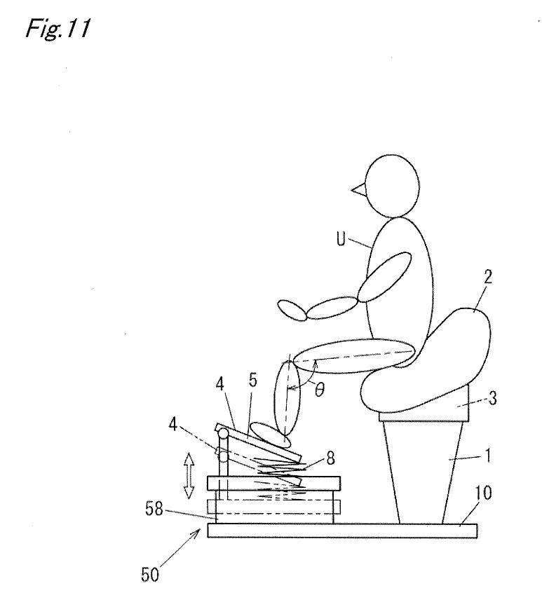

Next, a third embodiment of the passive exercise apparatus in this invention is explained with FIG. 11 to FIG. 13. In this embodiment, the passive exercise apparatus in this embodiment is substantially the same as the passive exercise apparatus explained in the first embodiment and the second embodiment. Therefore, features different from the first embodiment is explained in this embodiment. In the drawings, like parts are designated by the same reference numerals.

The passive exercise apparatus in this embodiment comprises the seat 2, the driving unit 3, the base 10, a pair of the footrests 4, the housing 1, and a positioning mechanism 50b. The base 10 is provided for mounting a pair of the footrests 4 and the seat 2 which is disposed on the housing 1. The positioning mechanism 50b is configured to slide the footrest 4 in the frontward or rearward direction of the seat 2 and the driving unit 3.

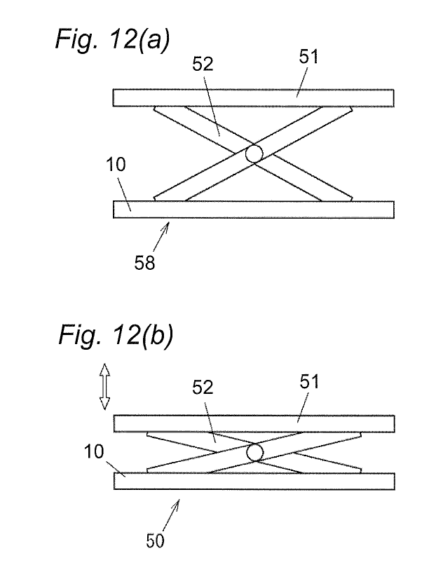

The positioning mechanism 50b in FIG. 12 comprises a supporting plate 51 and a pantograph jack 52. This positioning mechanism 50b is, so called a lifting and lowering device 58. The footrest 4 is disposed on the supporting plate 51. The supporting plate 51 is disposed on the pantograph jack 52. The pantograph jack 52 is composed of X-shaped link 53 and is disposed on the base 10. The pantograph jack 52 is configured to lift and lower the footrest 4 on the supporting plate 51. The pantograph jack 52 is configured to jack up the supporting plate 51, thereby vertically moving the footrest 4. With this configuration, it is possible to obtain the passive exercise apparatus which is configured to vary a vertical distance between the seating face 21s of the seat 2 and the upper surface 5s of the footplate 5.

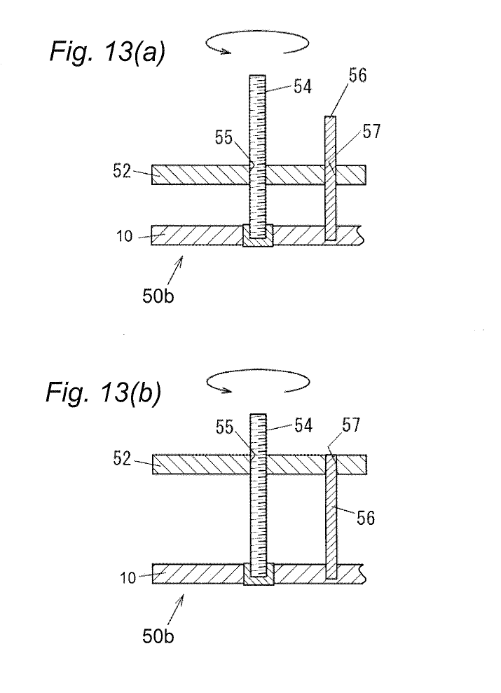

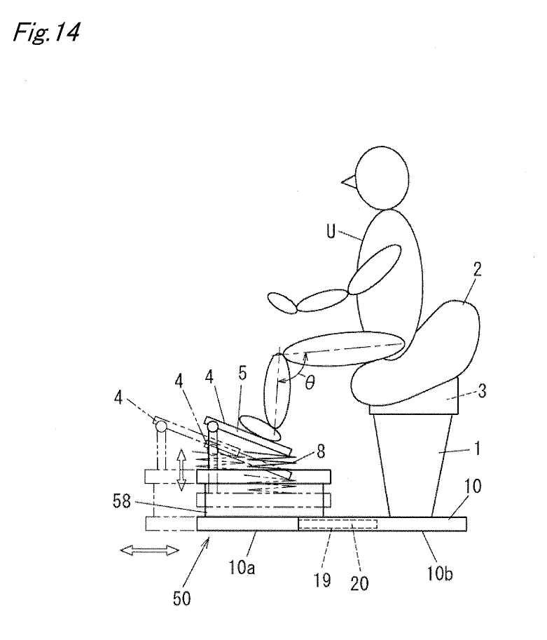

On the other hand, FIG. 13 shows a modification of the positioning mechanism 50b. The positioning mechanism 50b in this modification comprises a supporting plate 52, a jackscrew 54, a guide pin 56, and a motor which is not shown in FIG. 13. The jackscrew 54 has one end which is fixed to base 10 to be rotatable around an axis of the jackscrew 54. The guide pin 56 has one end fixed to the base 10 and extends parallel to the jackscrew 54 from the base 10. The supporting plate 52 is formed at its center portion with a threaded hole 55 which passing through the supporting plate 52 along its thickness direction, and is formed at with a through hole 57 along its thickness direction. The supporting plate 52 is connected to the jackscrew 54 to be movable along the axis of the jackscrew 54. The motor is configured to rotate the jackscrew 54, thereby the motor moving the supporting plate 52 along the axis of the jackscrew 54.

With this configuration, it is possible to obtain the passive exercise apparatus with the positioning mechanism 50b which is configured to move the footrest 4 upward or downward direction in order to vary a vertical distance between the upper surface 5s and the seating face 21s of the seat 2. Therefore, the passive exercise apparatus is configured to swing the seat 2 in order to apply the reciprocating motion to the user U with keeping the user's knee at suitable angle according to a lot of the different users having different body types. That is, when a tall user uses the passive exercise apparatus, the tall user moves the footrest 4 downward direction in order to increase the distance between the seating face 21s and the upper surface 5s. In this way, the passive exercise apparatus applies the reciprocating motion to the tall user with keeping knee angle at 90 degrees. On the other hand, when a short user uses the passive exercise apparatus, the short user moves the footrest 4 upward direction in order to shorten the distance between the seating face 21s and the upper surface 5s which defines the top face. In this way, the passive exercise apparatus applies the reciprocating motion to the short user with keeping knee angle at 90 degrees.

Meanwhile, it is preferred that the positioning mechanism is configured to move the footrest 4 frontward or rearward, and upward or downward direction. This positioning mechanism is obtained by combining the positioning mechanism 50 in the second embodiment and the positioning mechanism 50b in the third embodiment. In this way, the passive exercise apparatus is configured to apply the reciprocating motion to the user U on the seat 2 with keeping the user's knee angle at desired angle that a lot of the different users having different body types.

### Fourth Embodiment

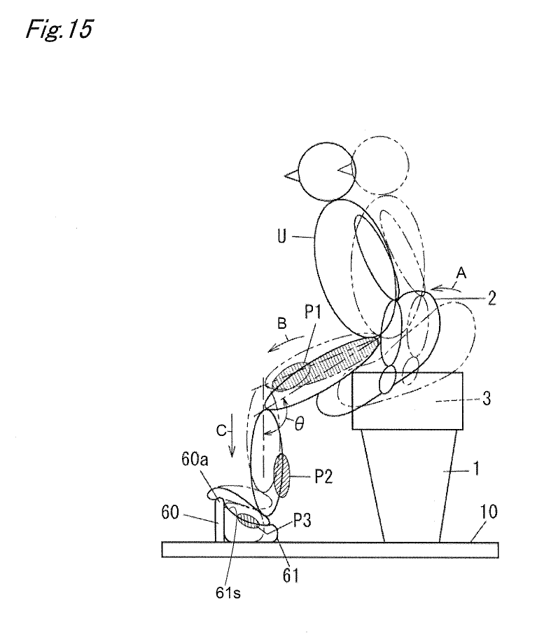

FIG. 15 shows a fourth embodiment of the passive exercise apparatus in this invention. In this embodiment, the passive exercise apparatus in this embodiment is substantially the same as the passive exercise apparatus explained in the first embodiment, the second embodiment, and the third embodiment. Therefore, features different from the first embodiment, the second embodiment, and the third embodiment are explained in this embodiment. In the drawings, like parts are designated by the same reference numerals.

The passive exercise apparatus in this embodiment comprises the seat 2, the driving unit 3, the base 10, a pair of footrests 4b, and the housing 1. The base 10 is provided for mounting a pair of the footrests 4b and the seat 2 which is disposed on the housing 1.

As shown in FIG. 15, both of the footrests 4b comprises a toe support 60 and an air bag 61. The toe support 60 is disposed on the base 10 to be located at a front side of the seat 2. The air bag 61 is disposed on the base 10 to be located at a front side of the seat 2 and to be located behind the toe support 60. Both of the toe supports 60 has a supporting end 60a which is provided for supporting a user's left toe or a user's right toe. Both of the air bags 61 is provided with upper surface for supporting a user's left foot or right foot other than the toe. That is, the upper surface 61s of the air bag 61 is defined as the top face. The air bag 61 is configured to move the upper surface 61s from the raised position toward the lowered position when the air bag 61 receives the pressure. In addition, when the air bag 61 receives the pressure, the air bag 61 deforms and generates an elastically rebound. Therefore, the air bag 61 has an upper surface which acts as the elastically deformable member. Meanwhile, the passive exercise apparatus in this embodiment employs the air bag as the elastically deformable member. However, the elastically deformable member is not limited to the air bag. For example, it is possible to employ a gel bag as the elastically deformable member instead of the air bag.

When the passive exercise apparatus with the above configuration applies the reciprocating motion to the user U on the seat 2, both of the user's heels alternately moves toward the lower side, while the user's toe being supported by both of the toe supports 60. The broken line in FIG. 15 shows a condition where the user's heel moves toward the lower side. Because of the doresiflex motion of the user's foot, the passive exercise apparatus in this embodiment is also applies the reciprocating motion to the user U to brace user's feet with keeping the user's knee at almost 90 degrees and without moving the user's knee toward the front side and the rear side. Especially, the passive exercise apparatus is configured to apply the eccentric training to the user's gastrocnemius. In addition, because the portion of the user's foot other than the user's toe is supported by an upper surface of the elastically deformable member such as the air bag, the passive exercise apparatus is configured to apply a comfortable feeling for the user U when the user U braces the user's feet.

Meanwhile, the passive exercise apparatus comprises the elastically deformable member which comes into contact with the portion of the foot other than the toe. However, it is preferred that the air bag 61 is formed to come into contact with the portion of the feet other than the user's heel. With this configuration, it is possible to effectively strengthen the user's plantar arch P3 shown in FIG. 15. Furthermore, it is preferred that the passive exercise apparatus further comprises a pump which is configured to automatically supply and discharge air in the air bag 61 according to the motion that the user U brace the feet.

By the way, the driving unit 3 is configured to swing the seat 2 frontward and rearward, and is configured to move the seat 2 upward and downward repeatedly. However, it is possible to employ a driving unit 3 which is configured to only swing the seat 2 frontward and rearward. Similarly, it is possible to employ a driving unit 3 which is configured to only move the seat 2 upward and downward. The passive exercise apparatus with these driving units 3 are configured to apply the reciprocating motion to the user U to brace user's feet with keeping the user's knee angle at almost 90 degrees and without moving the user's knee toward a front side and rear side. Therefore, the passive exercise apparatus is configured to apply the eccentric training to the user U, especially the user's gastrocnemius.

The driving unit 3 without link 35 and having the movable frame 30 fixed to the main cover and having a lower end of the actuator 45 is supported to the movable frame 30 is configured to vertically swing the seat 2. On the other hand, the driving unit 3 without the link 35 and coupling link 36, and having the movable frame 30 fixed to the main cover 18 is configured to swing the seat 2 vertically. In addition, it is possible to move the seat 2 by the actuator 45.

1. A passive exercise apparatus comprising:
a base;
a seat being disposed on said base;
a driving unit being configured to reciprocate said seat past its neutral position relative to said bass;
a pair of footrests being arranged on said base at a front of said seat and being spaced from said seat by a predetermined distance,
wherein
each of said footrest has a top face for contact with a user's foot, each of said footrest being configured to move said top face between a raised position and a lowered position, and said footrest having said top face being elastically urged toward said raised position.

2. A passive exercise apparatus as set forth in claim 1, wherein
said footrest comprises a footplate, a post, and a bias means,
said footplate being pivotally fixed to said post, said footplate defining said top face on its upper surface, and
said bias means being configured to apply bias to said footplate in order to move said footplate from said lowered position toward said raised position.

3. A passive exercise apparatus as set forth in claim 1, wherein
said footrest comprises a toe support and an elastically deformable member with an upper surface which defines said top face, said elastically deformable member being deformable under pressure to move said top face between said raised position and said lowered position.

4. A passive exercise apparatus as set forth in claim 2, wherein
said driving unit is configured to swing said seat back and forth past said neutral position in a forward/rearward direction of said base.

5. A passive exercise apparatus as set forth in claim 2, wherein
said driving unit is configured to move said seat up and down past said neutral position in a vertical direction.

6. A passive exercise apparatus as set forth in claim 2, wherein
said passive exercise apparatus further comprises a positioning mechanism being configured to slide said footrest in a forward or rearward direction in order to vary said predetermined distance.

7. A passive exercise apparatus as set forth in claim 2, wherein
said passive exercise apparatus further comprises a positioning mechanism being configured to move said footrest upward or downward direction in order to vary a distance between said top face and a seating face of said seat.

8. A passive exercise apparatus as set forth in claim 2, wherein
said footplate is formed to have a shape so as to support with a portion of the foot other than a user's heel.

9. A passive exercise apparatus as set forth in claim 3, wherein
said elastically deformable member is formed to have a shape so as to support a portion other than a user's toe.

10. A passive exercise apparatus as set forth in claim 3, wherein
said elastically deformable member is formed to have a shape so as to support a portion other than a user's heel.

11. A passive exercise apparatus as set forth in claim 3, wherein
said driving unit is configured to swing said seat back and forth past said neutral position in a forward/rearward direction of said base.

12. A passive exercise apparatus as set forth in claim 3, wherein
said driving unit is configured to move said seat up and down past said neutral position in a vertical direction.

13. A passive exercise apparatus as set forth in claim 3, wherein
said passive exercise apparatus further comprises a positioning mechanism being configured to slide said footrest in a forward or rearward direction in order to vary said predetermined distance.

14. A passive exercise apparatus as set forth in claim 3, wherein
said passive exercise apparatus further comprises a positioning mechanism being configured to move said footrest upward or downward direction in order to vary a distance between said top face and a seating face of said seat.
